(19) United States
(12) Patent Application Publication
(10) Pub. No.: US 2015/0098254 A1
(43) Pub. Date: Apr. 9, 2015

(54) CONTROLLER FOR USE WITH A POWER CONVERTER AND METHOD OF OPERATING THE SAME

(71) Applicant: Power Systems Technologies Ltd., Ebene (MU)

(72) Inventors: Antony Brinlee, Plano, TX (US); Steven Malechek, Murphy, TX (US)

(73) Assignee: Power Systems Technologies Ltd., Ebene (MU)

(21) Appl. No.: 14/049,355

(22) Filed: Oct. 9, 2013

(51) Int. Cl. H02M 3/335

(52) U.S. Cl. CPC H02M 3/33507
USPC 363/21.02

(57) ABSTRACT

A controller for use with a power converter and method of operating the same. In one embodiment, the controller includes a gate drive terminal configured to provide a gate drive signal to enable conductivity of a power switch during a first portion of a switching interval and to disable conductivity of the power switch during a second portion of the switching interval. The controller also includes a current sense terminal configured to receive a power switch signal indicative of a current in the power switch during the first portion of the switching interval, and receive a control signal to operate the power converter or provide a status signal indicative of an operating condition of the power converter during the second portion of the switching interval.

### TECHNICAL FIELD

The present invention is directed, in general, to power electronics and, more specifically, to a controller for use with a power converter and method of operating the same.

### BACKGROUND

A switched-mode power converter (also referred to as a “power converter” or “regulator”) is a power supply or power processing circuit that converts an input voltage waveform into a specified output voltage waveform. A power factor correction (“PFC”)/resonant inductor-inductor-capacitor (“LLC”) power converter includes a power train with a PFC stage followed by an LLC stage. The power converter is coupled to a source of electrical power (an alternating current (“ac”) power source) and provides a direct current (“dc”) output voltage. The PFC stage receives a rectified version of the ac input voltage (from the ac power source) and provides a dc bus voltage. The LLC stage employs the bus voltage to provide the dc output voltage to a load. The power converter including the PFC stage and the LLC stage can be employed to construct an “ac adapter” to provide the dc output voltage to a notebook computer or the like from the ac power source.

Controllers associated with the power converter manage an operation thereof by controlling conduction periods of power switches employed therein. Generally, the controllers are coupled between an input and output of the power converter in a feedback loop configuration (also referred to as a “control loop” or “closed control loop”). Two control processes are often employed to control the output voltage of a power converter formed with the PFC stage followed by the LLC stage. One process controls the bus voltage of the PFC stage to control the output voltage, and the other process controls the switching frequency of the LLC stage to control the output voltage.

An area of interest with respect to power converters is the continuing need to reduce the size and footprint in the face of increasing complexity in interfaces with supported systems. A particular area of concern is the number of pins/terminals required to communicate signals between a power converter and the supported system. Pins/terminals are generally physical elements that bear a cost as well as physical size. Accordingly, what is needed in the art is a controller that can be formed with fewer terminals and can support increased complexity of interfaces with supported systems.

### SUMMARY OF THE INVENTION

Technical advantages are generally achieved, by advantageous embodiments of the present invention, including a controller for use with a power converter and method of operating the same. In one embodiment, the controller includes a gate drive terminal configured to provide a gate drive signal to enable conductivity of a power switch during a first portion of a switching interval and to disable conductivity of the power switch during a second portion of the switching interval. The controller also includes a current sense terminal configured to receive a power switch signal indicative of a current in the power switch during the first portion of the switching interval, and receive a control signal to operate the power converter or provide a status signal indicative of an operating condition of the power converter during the second portion of the switching interval.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a power converter including a controller constructed according to the principles of the present invention;

FIG. 2 illustrates a schematic diagram of a portion of power converter including an exemplary power train employing a boost topology constructed according to the principles of the present invention;

FIG. 3 illustrates a schematic diagram of an embodiment of a power converter formed with a PFC stage coupled to an LLC stage constructed according to the principles of the present invention;

FIGS. 4 to 6 illustrate graphical representations of exemplary operating characteristics of a power converter according to the principles of the present invention;

FIGS. 7 and 8 illustrate block diagrams of embodiments of power converters formed with a PFC stage coupled to an LLC stage constructed according to the principles of the present invention;

FIGS. 9 and 10 illustrate diagrams of embodiments of a portion of an LLC stage coupled to an LLC controller constructed according to the principles of the present invention;

FIGS. 11 and 12 illustrate block diagrams of embodiments of a controller formed with an LLC controller and a data isolation circuit constructed according to the principles of the present invention; and

FIG. 13 illustrates graphical representations demonstrating exemplary operating characteristics of a power converter according to the principles of the present invention.

Corresponding numerals and symbols in the different figures generally refer to corresponding parts unless otherwise indicated, and may not be redescribed in the interest of brevity after the first instance. The FIGUREs are drawn to illustrate the relevant aspects of exemplary embodiments.

### DETAILED DESCRIPTION OF ILLUSTRATIVE EMBODIMENTS

The making and using of the present exemplary embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to exemplary embodiments in a specific context, namely, a controller for a power converter with increased functionality for a current sense pin/terminal. While the principles of the present invention will be described in the environment of a controller for a power factor correction (“PFC”)/resonant inductor-inductor-capacitor (“LLC”) power converter, any application that may benefit from a controller such as a power amplifier or a motor controller is well within the broad scope of the present invention.

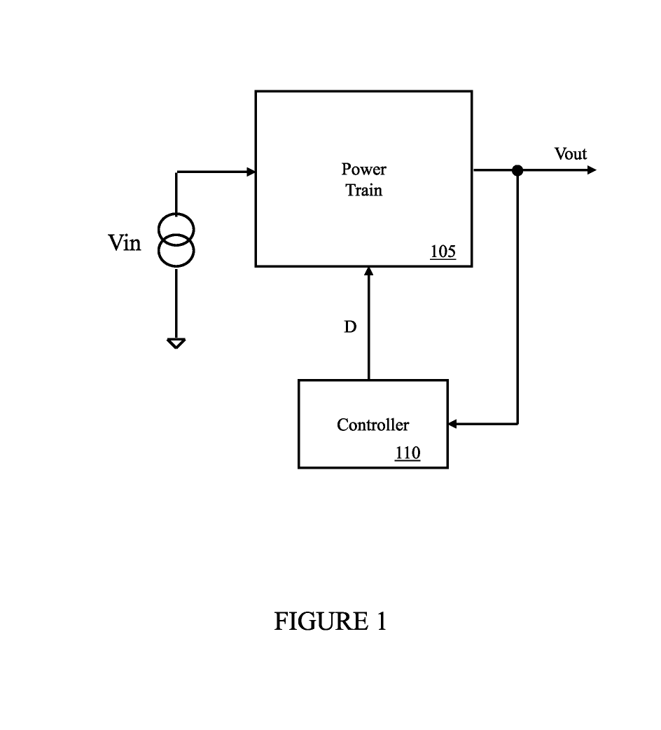

Referring initially to FIG. 1, illustrated is a block diagram of an embodiment of a power converter including a controller 110 constructed according to the principles of the present invention. The power converter is coupled to ac mains represented by the ac power source providing an input voltage Vin. The power converter includes a power train 105 that is controlled by the controller 110. The controller 110 generally measures an operating characteristic of the power converter such as an output voltage Vout and controls a duty cycle D of a power switch therein in response to the measured operating characteristic to regulate the characteristic. The power train 105 may include multiple power stages to provide a regulated output voltage Vout or other output characteristic to a load. The power train 105 of the power converter includes a plurality of power switches coupled to a magnetic device to provide the power conversion function.

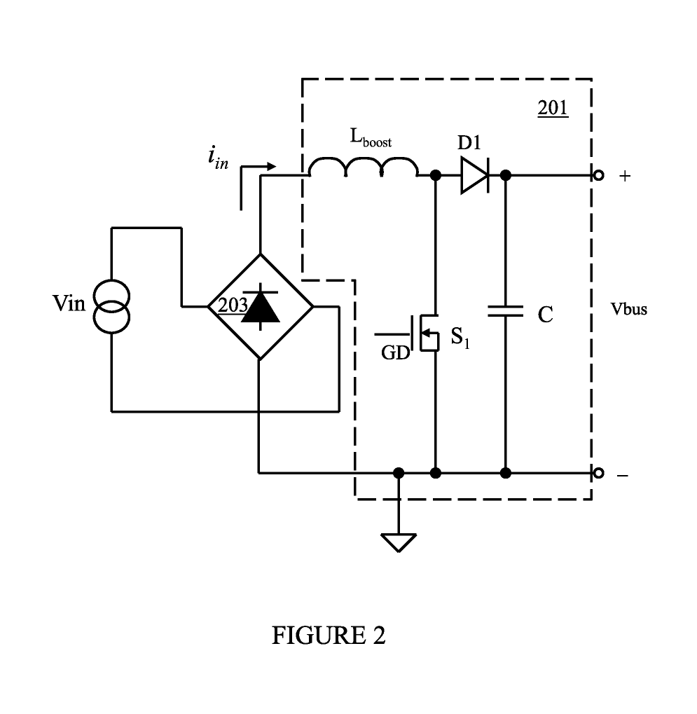

Turning now to FIG. 2, illustrated is a schematic diagram of a portion of power converter including an exemplary power train (e.g., a PFC stage 201) employing a boost topology (e.g., a PFC boost stage) constructed according to the principles of the present invention. The PFC stage 201 of the power converter receives an input voltage Vin (e.g., an unregulated ac input voltage) from a source of electrical power such as ac mains at an input thereof and provides a regulated dc bus voltage (also referred to as a bus voltage) Vbus. In keeping with the principles of a boost topology, the bus voltage Vbus is generally higher than the input voltage Vin such that a switching operation thereof can regulate the bus voltage Vbus. A main power switch S₁, (e.g., an n-channel metal-oxide semiconductor (“NMOS”) “active” switch) is enabled to conduct by a gate drive signal GD for a primary interval and couples the input voltage Vin through a bridge rectifier 203 to a boost inductor L_{boost}. During a primary interval D of a switching cycle, an inductor current iᵢₙ increases and flows through the boost inductor L_{boost} to local circuit ground. The boost inductor L_{boost} is generally formed with a single-layer winding to reduce the proximity effect to increase the efficiency of the power converter.

The duty cycle D for the PFC stage 201 depends in steady state on the ratio of the input voltage and the bus voltage Vin, Vbus, respectively, according to the equation:

$$D = 1 - \frac{Vin}{Vbus} .$$

During a complementary interval 1-D, the main power switch S₁ is transitioned to a non-conducting state and an auxiliary power switch (e.g., the diode D1) conducts. In an alternative circuit arrangement, the auxiliary power switch may include a second active switch that is controlled to conduct by a complementary gate drive signal. The auxiliary power switch D1 provides a path to maintain a continuity of the inductor current iᵢₙ flowing through the boost inductor L_{boost}. During the complementary interval 1-D, the inductor current iᵢₙ flowing through the boost inductor L_{boost} decreases, and may become zero and remain zero for a period of time resulting in a “discontinuous conduction mode” of operation.

During the complementary interval 1-D, the inductor current iᵢₙ flowing through the boost inductor L_{boost} flows through the diode D1 (i.e., the auxiliary power switch) into a filter capacitor C. In general, the duty cycle D of the main power switch S₁ (and the complementary duty cycle of the auxiliary power switch D1) may be adjusted to maintain a regulation of the bus voltage Vbus of the PFC stage 201. Those skilled in the art understand that conduction periods for the main and auxiliary power switches S₁, D1 may be separated by a small time interval by the use of “snubber” circuit elements (not shown) or by control circuit timing to avoid cross conduction current therebetween, and beneficially to reduce the switching losses associated with the power converter. Circuit and control techniques to avoid cross-conduction currents between the main and auxiliary power switches S₁, D1 are well understood in the art and will not be described further in the interest of brevity. The boost inductor L_{boost} is generally formed with a single-layer winding to reduce power loss associated with the proximity effect.

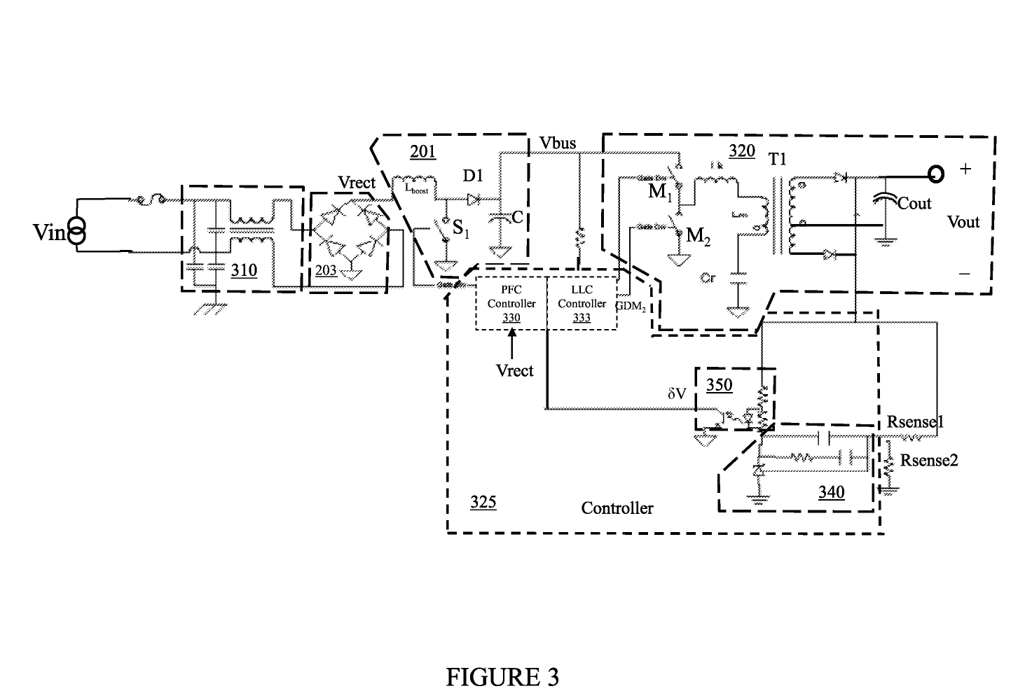

Turning now to FIG. 3, illustrated is a schematic diagram of an embodiment of a power converter formed with a PFC stage (such as the PFC stage 201 of FIG. 2) coupled to an LLC stage 320 (e.g., a half-bridge LLC isolated resonant buck stage) constructed according to the principles of the present invention. The PFC stage 201 and the LLC stage 320 can be employed to construct an “ac adapter” to provide a dc output voltage Vout (e.g., 19.5 volts) to a notebook computer from an ac mains source (represented by input voltage Vin).

As mentioned above, two control processes are often employed to control the output voltage Vout of a power converter formed with a PFC stage 201 followed by the LLC stage 320. One process controls the bus voltage Vbus of the PFC stage 201 to control the output voltage Vout, and the other process controls the switching frequency (also designated switching frequency fₛ) of the LLC stage 320 to control the output voltage Vout. The bus voltage Vbus produced by the PFC stage 201 is controlled in a slower response feedback loop in response to a load coupled to an output of the LLC stage 320. The LLC stage 320 is operated at a switching frequency fₛ that is selected to augment the power conversion efficiency thereof. The LLC stage 320 is operated continuously in an ideal transformer state with the bus voltage Vbus produced by the PFC stage 320 controlled to compensate an “IR” (current times resistance) drop in the LLC stage 320. Usually the variation of the bus voltage Vbus produced by the PFC stage 201 is of the order of a few tens of volts.

Using switching frequency fₛ to control the LLC stage 320, the PFC stage 201 produces a constant dc bus voltage Vbus, but the LLC stage 320 is operated with a switching frequency fₛ that is controlled with a fast response control loop (i.e., a control loop with a high crossover frequency) in response to variations in a load coupled to an output of the power converter. Altering the switching frequency fₛ of the LLC stage 320 generally causes the LLC stage 320 to operate at a non-efficient switching frequency.

A hybrid control approach is provided wherein the bus voltage Vbus produced by the PFC stage 201 is controlled with a slower response control loop (i.e., a control loop with a low crossover frequency) to handle the average load power. The switching frequency fₛ of the LLC stage 320 is controlled with a fast response feedback loop to handle load transients and ac mains dropout events. Controlling the PFC stage 201 to control the output voltage Vout leads to several design issues. First, the bus voltage Vbus generally exhibits poor transient response due to a low PFC control-loop crossover frequency. Second, there is a substantial ripple voltage (e.g., a 100-120 hertz ripple voltage) on the bus voltage Vbus that supplies the LLC stage 320 that appears on the output thereof.

The switching frequency fₛ of the LLC stage 320 is controlled with a fast response control loop to attenuate the effect of the ripple voltage produced by the PFC stage 201 that ordinarily appears on the output of the LLC stage 320. In addition, the transformer/stage gain of the LLC stage 320 is employed with a fast response control loop in a frequency region between 1/(2π·sqrt((Lₘ+Lₖ)·Cᵣ)) and 1/(2π·sqrt(Lₖ·Cᵣ)) to accommodate large load step changes and ac mains input voltage Vin dropout events. The bus voltage Vbus of the PFC stage 201 is controlled in response to slow changes in the load to enable the LLC stage 320 to operate ideally at or near its resonant frequency, at which point its power conversion efficiency is generally best. By operating the LLC stage 320 most of the time at or near its resonant frequency, but allowing the switching frequency fₛ to change in response to transients, improved load step response, reduced output voltage ripple, and higher power conversion efficiency can be obtained.

The primary inductance of the transformer T1 is the leakage inductance Lₖ plus the magnetizing inductance Lₘ, both inductances referenced to the primary winding of the transformer T1. The resonant capacitor is Cᵣ. The resonant capacitor Cᵣ can be split into two capacitors coupled in a series circuit, one end of the series circuit coupled to ground and the other end coupled to the bus voltage Vbus. A series circuit arrangement can be employed to reduce inrush current at startup. An ideal switching frequency for fₛ is fₒ=1/(2π·sqrt(Lₖ·Cᵣ)), which is normally the high-efficiency operating point (e.g., 50 kilohertz (“kHz”)). The low switching frequency fₛ at which inefficient capacitive switching starts is fₘᵢₙ=1/(2π·sqrt(Lₚ·Cᵣ)). It is generally desired to operate at switching frequencies fₛ greater than the minimum switching frequency fₘᵢₙ, and even avoid switching frequencies fₛ that approach the same.

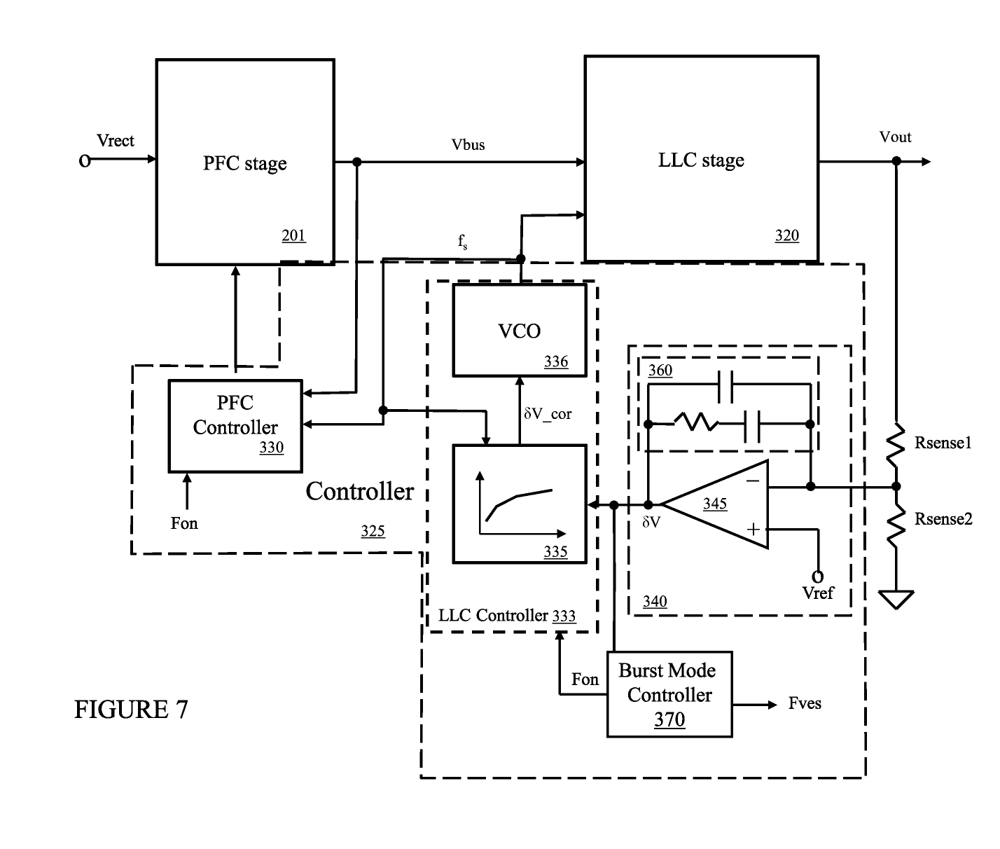

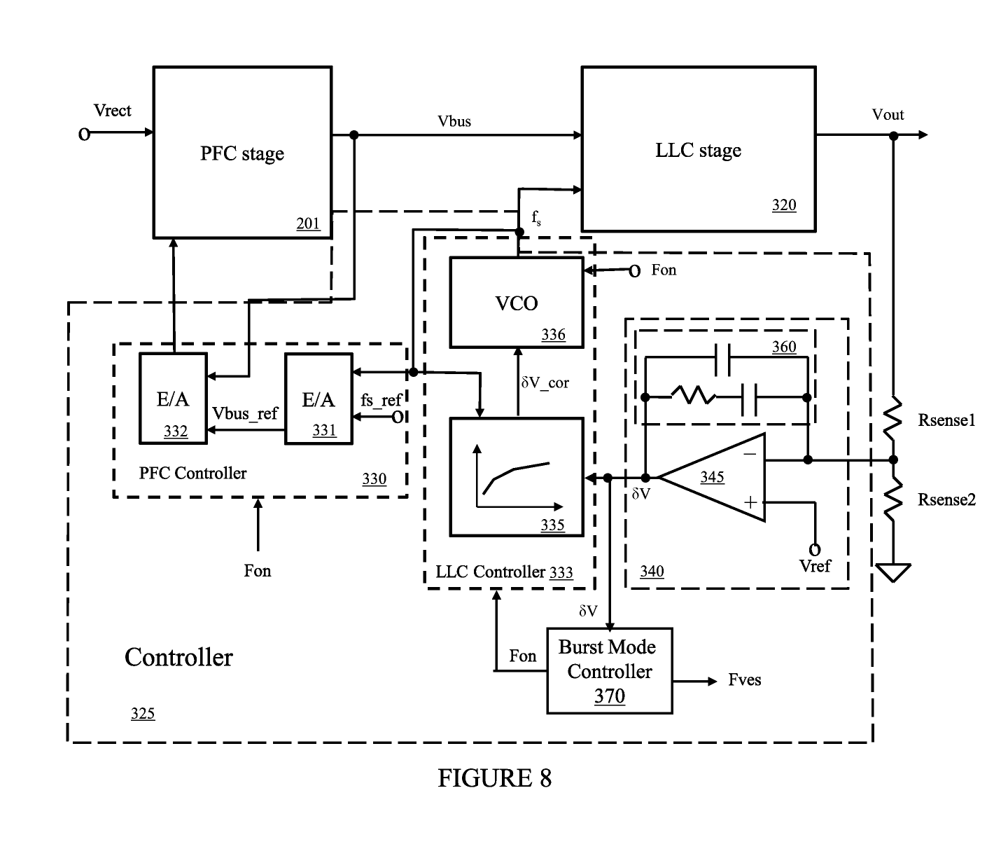

A controller 325 has an input for the bus voltage Vbus and an input for the output voltage Vout of the power converter from a feedback circuit including an optocoupler 350. A voltage controlled oscillator (“VCO”) 336 controls the switching frequency fₛ of the LLC stage 320 as illustrated and described hereinbelow with reference to FIGS. 7 and 8. Thus, the PFC stage 201 and the LLC stage 320 are jointly controlled in voltage and frequency domains. As described further hereinbelow, the operation of the controller 325 is tested from time to time so that a burst mode can be entered at light loads.

As illustrated in FIG. 3, the input voltage Vᵢₙ is coupled to electromagnetic interference (“EMI”) filter 310, the output of which is coupled to bridge rectifier 203 to produce a rectified voltage Vrect. The PFC stage 201 produces the bus voltage Vbus that is coupled to the input of the LLC stage 320 to produce the output voltage Vout, filtered by an output filter capacitor Cout of the power converter. In an alternative embodiment, the LLC stage 320 may be formed with a full-bridge topology. The output voltage Vout is sensed with an error amplifier 340 coupled to a resistor divider formed with first and second resistors Rsense1, Rsense2. The output signal from the error amplifier 340 is coupled to the optocoupler 350, which produces an output voltage error signal (also referred to as an “error signal”) δV. The output voltage error signal δV and the bus voltage Vbus are coupled to a PFC controller 330 and/or an LLC controller 333 (hereinafter described in more detail below with respect to FIG. 7) of the controller 325. The controller 325 jointly controls the bus voltage Vbus produced by the PFC stage 201 and the switching frequency fₛ of the LLC stage 320 to regulate the output voltage Vout while maintaining the switching frequency fₛ (most of the time) at the high-efficiency operating point of the LLC stage 320.

In operation, a zero-to-full load step change in a load coupled to the output voltage Vout can, for example, cause the bus voltage Vbus to sag from 370 volts down to 290 volts due to the inherently low crossover frequency of the controller 325. By dropping the switching frequency fₛ of the LLC stage 320 from 50 kHz to 25 kHz with a fast response control loop, the increased voltage gain of the LLC stage 320, which can be 1.3 to 1 or higher, can be used to substantially compensate for the sag in the bus voltage Vbus. As the bus voltage Vbus recovers to about 390 volts to compensate for the IR drop in the LLC stage 320, the switching frequency fₛ thereof returns to 50 kHz.

The same principle can be applied to a holdup event when the ac mains voltage (the input voltage Vin) drops out. The residual energy stored in the filter capacitor C of the PFC stage 201 can be employed to maintain regulation of the output voltage Vout while the bus voltage Vbus sags from 390 volts to 280 volts. Again, the frequency-dependent voltage gain of the LLC stage 320 is used in response to a fast response control loop to regulate the output voltage Vout of the power converter. The response of the LLC stage 320 can thereby be employed to reduce the size of the filter capacitor C of the PFC stage 201 or to increase the ride-through time of the power converter for ac input voltage (the input voltage Vin) sags. Nonlinear feedback is employed for control loop compensation as described further hereinbelow.

The PFC controller 330 provides a gate drive signal for the main power switch S₁ of the PFC stage 201 during the primary and complementary duty cycles D, 1-D of a switching cycle and the LLC controller 333 provides gate drive signals for the main and auxiliary power switches M₁, M₂ of the LLC stage 320 during the primary and complementary intervals D, 1-D of a switching cycle. The PFC controller 330 also employs the rectified voltage Vrect to control a low frequency current waveform from the bridge rectifier 203. A gate drive signal designated GDM₂ represents the gate drive signal to the auxiliary power switch M₂ during the complementary interval 1-D for the LLC stage 320. It should be recognized that the primary interval D of the switching cycle for the main power switch M₁ is the complementary interval 1-D for the auxiliary power switch M₂ because main power switch M₁ and the auxiliary power switch M₂ are enabled to conduct in complementary time intervals.

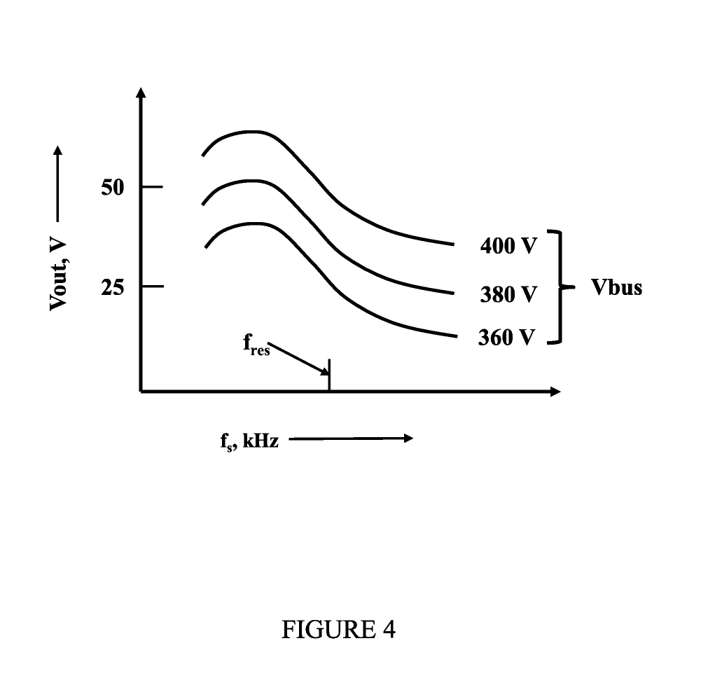

Turning now to FIGS. 4 to 6, illustrated are graphical representations of exemplary operating characteristics of a power converter according to the principles of the present invention. FIG. 4 illustrates a voltage transfer characteristic of an LLC stage of a power converter. The output voltage Vout of the LLC stage (and power converter) at a particular bus voltage Vbus (such as 400 volts) from a PFC stage depends in a nonlinear way on the switching frequency fₛ of the LLC stage. As the bus voltage Vbus is reduced, the output voltage Vout is approximately proportionately reduced if the switching frequency fₛ is not altered. The result is that the switching frequency fₛ can be varied to control the output voltage Vout as the bus voltage Vbus varies. The effect of changing the switching frequency fₛ on the output voltage Vout, however, is nonlinear. The resonant frequency fᵣₑₛ represents the resonant frequency of the LLC stage.

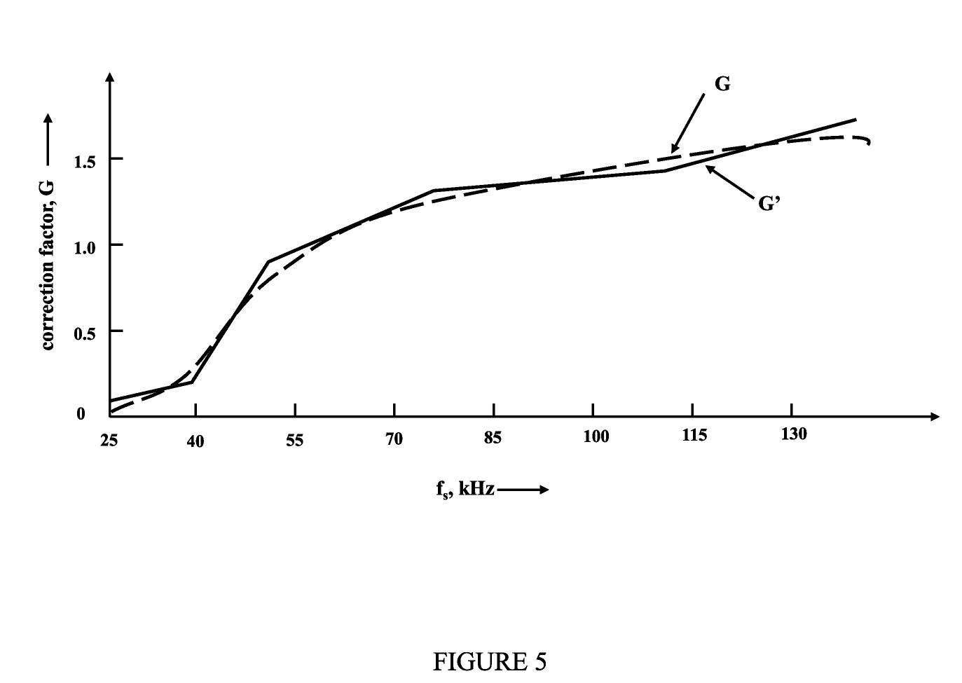

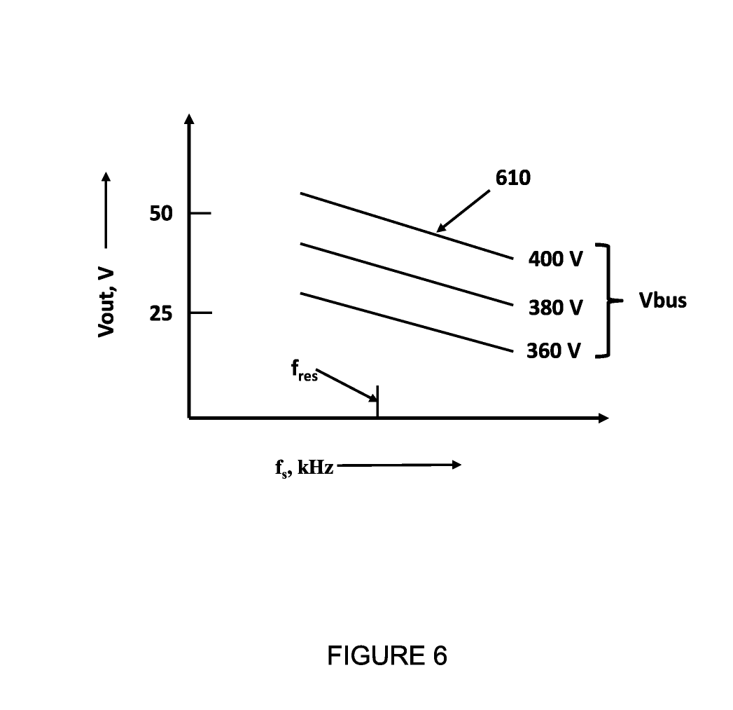

Turning now to FIG. 5, illustrated is a graphical representation of a correction factor G that is an inverse function to the frequency-dependent curves illustrated in FIG. 4. A frequency-dependent curve as illustrated in FIG. 4 multiplied by the correction factor G produces straight lines for a frequency-dependent characteristic of the voltage transfer characteristic of the LLC stage. The result of multiplication by the correction factor G is illustrated in FIG. 6, such as a straight line 610 for the bus voltage Vbus equal to 400 volts. In an embodiment, the correction factor G is approximated by a broken line correction factor (such as the five-segment broken line correction factor) G′ illustrated in FIG. 5.

Turning now to FIG. 7, illustrated is a block diagram of an embodiment of a power converter formed with a PFC stage (such as the PFC stage 201 of FIG. 2) coupled to an LLC stage (such as LLC stage 320 of FIG. 3) and a controller (such as controller 325 of FIG. 3) constructed according to the principles of the present invention. The power converter receives an input voltage and provides a rectified voltage Vrect (via a bridge rectifier), which is converted by the PFC stage 201 and LLC stage 320 into an output voltage Vout. The output voltage Vout is sensed with the resistor divider formed with first and second resistors Rsense1, Rsense2, and the sensed output voltage is coupled to an inverting input of an operational amplifier 345 of an error amplifier 340. The error amplifier 340 includes a resistor capacitor network 360 in its feedback path to produce an output voltage error signal (also referred to as an “error signal”) δV.

Greater feedback loop stability is achieved by employing a nonlinear function subsystem 335 of an LLC controller 333 in the feedback loop to control the switching frequency fₛ of the LLC stage 320, to compensate for the frequency-dependent response thereof. In accordance with the nonlinear subsystem 335, a correction factor G is approximated in the form of a broken line correction factor (e.g., a five-segment broken line correction factor G′), which is applied to the output voltage error signal δV to produce a corrected error signal δV_cor. It should be understood that an optocoupler (such as optocoupler 350 illustrated in FIG. 3) may cooperate with the error amplifier 340 to produce the output voltage error signal δV. In an embodiment, a five-segment broken line correction factor G′ is employed in the nonlinear function subsystem 335 to reduce nonlinear feedback effects produced by the LLC stage 320. The five-segment broken line correction factor G′ may be more general referred to as a broken line correction factor. The corrected error signal δV_cor is coupled to the input of a voltage controlled oscillator (“VCO”) 336 of the LLC controller 333 that controls the switching frequency fₛ of the LLC stage 320. The nonlinear function subsystem 335 and the voltage controlled oscillator 336 form at least a portion of an LLC controller 333 (see, also, FIG. 3).

The switching frequency fₛ is also coupled to a PFC controller 330 that produces a gate drive signal GD for the main power switch S₁ of the PFC stage 201 (see FIG. 3). The PFC controller 330 senses the bus voltage Vbus of the PFC stage 201. The PFC controller 330 controls the bus voltage Vbus in a slower response control loop to maintain an average value of the switching frequency fₛ near the ideal switching frequency fₒ=1/(2π·sqrt(Lₖ·Cᵣ)) to maintain high power conversion efficiency of the LLC stage 320.

In a further aspect, the PFC controller 330 briefly elevates the bus voltage Vbus from time to time (e.g., by six or seven volts for 20 milliseconds) to generate an error in the error signal δV, or correspondingly in the corrected error signal δV_cor, to detect light-load operation so that a burst mode of operation can be entered. Burst-mode operation at light loads produces a significant improvement in power conversion efficiency in accordance with a burst mode controller 370 as described in more detail below. The bus voltage Vbus can be elevated by the PFC controller 330 by briefly elevating a reference voltage therein that is employed in conjunction with an error amplifier to regulate the bus voltage Vbus. As described hereinbelow with reference to FIG. 8, a bus voltage reference Vbus_ref coupled to an input of an error amplifier 332 is briefly elevated to enable detection of light-load operation. A burst mode is entered when the error signal δV or the corrected error signal δV_cor crosses a threshold level.

In operation at light load, the bus voltage Vbus is reduced to a low value due to reduce losses in the LLC stage 320. When the bus voltage Vbus is elevated for a short period of time, the induced change (e.g., reduction) in the error signal δV is used to determine whether to enter a burst mode. A higher bus voltage Vbus reduces the switching frequency of the LLC stage 320. A raised bus voltage Vbus and light load cause the error signal δV to go down sufficiently, which is detected to enter the burst mode. The burst mode is exited when the output voltage Vout drifts down to a threshold level, as indicated by elevation of the error signal δV. In a burst mode of operation, the switching actions of the PFC stage 201 and the LLC stage 320 are both shut down (e.g., the alternating characteristic of the duty cycle D for the gate drive signals to control the respective power switches is terminated).

Turning now to FIG. 8, illustrated is a block diagram of an embodiment of a power converter formed with a PFC stage (such as the PFC stage 201 of FIG. 2) coupled to an LLC stage (such as LLC stage 320 of FIG. 3) and a controller (including portions of the controller 325 of FIG. 7) constructed according to the principles of the present invention. The PFC controller 330 includes an error amplifier (“E/A”) 331 with one input, preferably an inverting input, coupled to the switching frequency fₛ produced by the voltage controlled oscillator (“VCO”) 336. The other input of the error amplifier 331, preferably a non-inverting input, is coupled to a frequency reference fs_ref that is a desired switching frequency fₛ for the LLC stage 320. In an embodiment, the desired switching frequency fₛ (akin to the ideal switching frequency) is fₒ=1/(2π·sqrt(Lₖ·Cᵣ)). The error amplifier 331 produces a bus voltage reference Vbus_ref that is employed by an error amplifier (“E/A”) 332 in a slower response control loop to regulate the bus voltage Vbus produced by the PFC stage 201. The bus voltage reference Vbus_ref is representative of a desired voltage level for the bus voltage Vbus that provides a high power-conversion efficiency for the power converter. In this manner, the controller 325 regulates the bus voltage Vbus produced by the PFC stage 201 to produce an average switching frequency fₛ for the LLC stage 320 that results in high power conversion efficiency therefor. The error amplifier 340 is retained to regulate the output voltage Vout of the power converter with a fast response control loop to enable the power converter to tightly regulate the output voltage Vout with a reduced level of ripple voltage that otherwise would be produced by a ripple voltage on the bus voltage Vbus of the PFC stage 201.

The burst mode controller 370 is coupled to the error signal δV produced by the error amplifier 340 to set the burst mode control signal Fon and the voltage elevate signal Fves. The error signal δV is related to and provides an indicator of the output voltage Vout of the power converter. When the burst mode control signal Fon is set high, switching action of the PFC stage 201 and the LLC stage 320 of the power converter are enabled. Conversely, when the burst mode control signal Fon is low, the switching action of the PFC stage 201 and the LLC stage 320 of the power converter are disabled. The voltage elevate signal Fves is employed to briefly raise the regulated output voltage Vout of the power converter so that low load power can be detected to enable entry into a burst mode of operation.

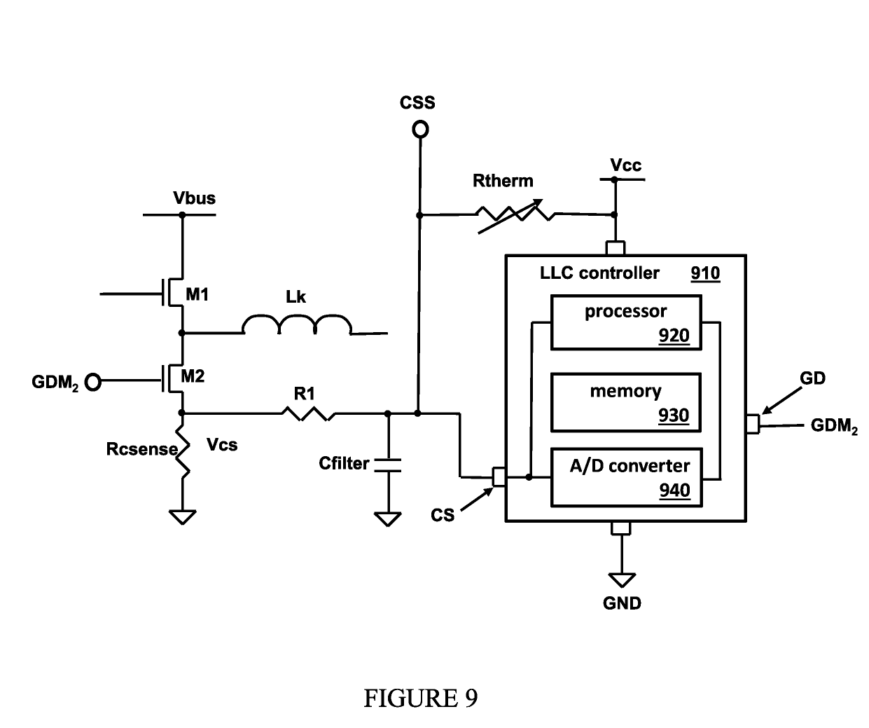

Turning now to FIG. 9, illustrated is a diagram of an embodiment of a portion of an LLC stage coupled to an LLC controller 910 constructed according to the principles of the present invention. A gate drive terminal GD of the LLC controller 910 provides a gate drive signal GDM₂ to enable an auxiliary power switch M₂ to conduct during a first portion of a switching cycle (in this case, a complementary interval also referred to as a “complementary duty cycle” 1-D) and to disable the auxiliary power switch M₂ to conduct during a second portion of the switching cycle (in this case, a primary interval also referred to as a “primary duty cycle” D). As introduced herein, a current sense terminal CS of the LLC controller 910 is configured to receive a power switch signal indicative of a current in the auxiliary power switch M₂ during the complementary duty cycle 1-D thereof, and to receive a control signal to operate the power converter or to provide a status signal indicative of an operating condition of the power converter during, for instance, the primary duty cycle D.

FIG. 9 illustrates the main and auxiliary power switches M₁, M₂ of the LLC stage with the source of the auxiliary power switch M₂ coupled to local circuit ground through current sense resistor Rcsense. A circuit node between the main power switch M₁ and the auxiliary power switch M₂ is coupled to a leakage inductance Lₖ, as illustrated and introduced hereinabove with reference to FIG. 3. The gate of auxiliary power switch M₂ is coupled to the gate drive signal GDM₂ produced by the LLC controller 910 at the gate drive terminal GD. A current sense voltage V_{CS} produced across the current sense resistor Rcsense is coupled through a resistor R1 (e.g., a one kiloohm (“kΩ”) resistor) to the current sense terminal CS of the LLC controller 910. A filter capacitor Cfilter (e.g., a 100 nanofarad (“nF”) ceramic capacitor) may be included in the circuit to attenuate spikes on voltage applied to the current sense terminal CS. During the conductivity-disabled portion of the switching cycle, current through auxiliary power switch M₂ can be assumed to be substantially zero, and a current sense terminal voltage at the current sense terminal CS can be employed to sense a parameter of the power converter or to communicate data (e.g., digital data) to or from the LLC controller 910.

The current sense terminal CS is coupled to a local bias voltage source Vcc (e.g., a 3.3 volt (“V”) bias voltage source) through a thermistor Rtherm. The current sense terminal voltage at the current sense terminal CS is thus set by a resistor divider network formed by the thermistor Rtherm and the series combination of the resistor R1 and the current sense resistor Rcsense. It is recognized that substantial current does not flow through the auxiliary power switch M₂ during the portion of the switching cycle when the auxiliary power switch M₂ is disabled to conduct. Thus, the current sense terminal CS can be employed by the LLC controller 910 to sense a parameter of the power converter.

The current sense terminal CS can be coupled to a synchronous serial port of the LLC controller 910. In an embodiment, the LLC controller 910 is a digital controller formed with a processor 920 (such as a microprocessor) coupled to memory 930 (such as a static random access memory (“SRAM”) and/or a flash memory). In an embodiment, the LLC controller 910 is programmed to sense current that flows through the auxiliary power switch M₂ under control of the gate drive signal GDM₂, and to sense a serial digital signal during the complementary duty cycle 1-D. In an embodiment, the LLC controller 910 is formed with analog-to-digital (“A/D”) converter 940 to convert a sensed parameter of the power converter from an analog to a digital signal. In an embodiment, the sensed parameter is sensed substantially in the middle of the time interval during which the auxiliary power switch M₂ is disabled to conduct.

In the circuit illustrated in FIG. 9, a dc current flows through the resistor divider network formed by the thermistor Rtherm coupled in series with the resistor R1 and the current sense resistor Rcsense. The resistance of the thermistor Rtherm is generally a substantially static value the changes slowly with an operating condition of the power converter. Accordingly, a small substantially dc bias voltage is superimposed on the current sense voltage V_{CS} produced by current sense resistor Rcsense when the auxiliary power switch M₂ is enabled to conduct. The time-varying voltage (the current sense voltage V_{CS}) produced across the current sense resistor Rcsense is employed by the LLC controller 910 to determine a duty cycle D for auxiliary power switch M₂ (or, alternatively for main power switch M₁). Recognizing that an integrating error amplifier is generally employed to determine the duty cycle D, the LLC controller 910 remains operable to control a characteristic of the power converter such as output voltage Vout despite the superimposed dc voltage produced by the thermistor Rtherm.

An industry-standard one-wire serial communication routine (e.g., a synchronization bit followed by a number of bytes) can be used by the LLC controller 910 to communicate with an external digital device at a control signal/status signal terminal CSS. During intervals of time when the LLC controller 910 does not communicate with the external digital device, the current sense terminal CS can also be employed to sense a parameter of the power converter.

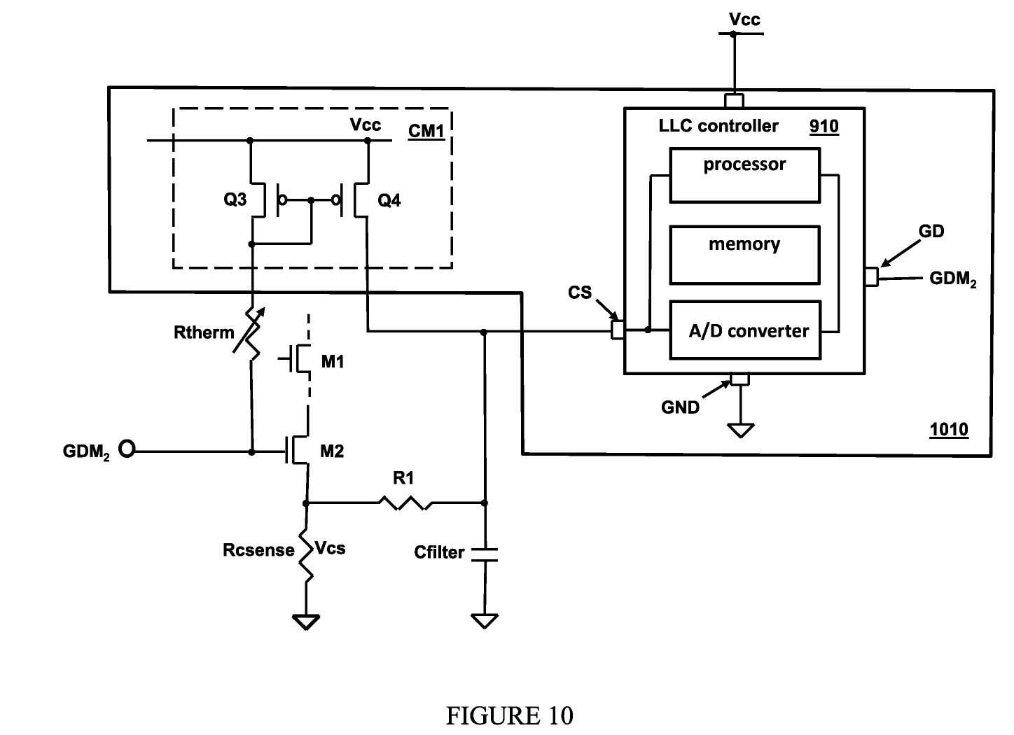

Turning now to FIG. 10, illustrated is a diagram of an embodiment of a portion of an LLC stage coupled to a controller 1010 constructed according to the principles of the present invention. The LLC stage includes main and auxiliary power switches M₁, M₂ with the source of the auxiliary power switch M₂ coupled to local circuit ground through a current sense resistor Rcsense. The controller 1010 includes a current mirror CM1 formed with P-channel metal-oxide semiconductor field-effect transistors (“MOSFETs”) Q3, Q4 and an LLC controller 910 described above with respect to FIG. 9. In an embodiment, the P-channel MOSFETs Q3, Q4 are matched P-channel MOSFETs formed on the same silicon die. The drain of the MOSFET Q4, which is the output current circuit element of the current mirror CM1, is coupled to a current sense terminal CS of the LLC controller 910. The drain of the MOSFET Q3, which is the input current circuit element of the current mirror CM1, is coupled through a thermistor Rtherm to a gate drive signal GDM₂ to produce a controlled current at the drain of the MOSFET Q4.

The time-varying voltage of the gate drive signal GDM₂ produces substantially zero current through the thermistor Rtherm during the on-period of the gate drive signal GDM₂, and a current substantially equal to a bias voltage Vcc divided by a resistance of the thermistor Rtherm during the off-period of the gate drive signal GDM₂. Thus, the current mirror CM1 produces a controlled current through the series combination of a resistor R1 and the current sense resistor Rcsense during a portion of the switching cycle of the auxiliary power switch M₂ (disabled to conduct), and no current through the series combination of the resistor R1 and the current sense resistor Rcsense when auxiliary power switch M₂ is enabled to conduct. In this manner, current produced by the thermistor Rtherm does not interfere with current that flows through the auxiliary power switch M₂ when the LLC controller 910 senses a current sense voltage Vcs across the current sense resistor Rcsense to terminate conduction of auxiliary power switch M₂. The current mirror CM1 provides a high impedance to the current sense terminal CS.

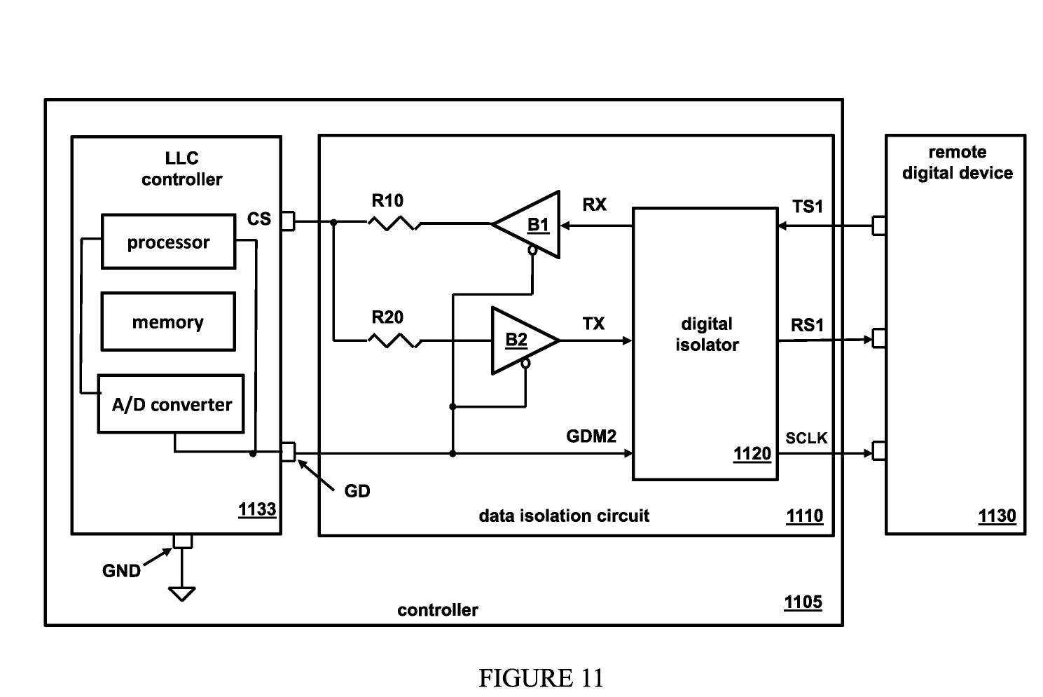

Turning now to FIG. 11, illustrated is a block diagram of an embodiment of a controller 1105 formed with an LLC controller 1133 and a data isolation circuit 1110 constructed according to the principles of the present invention. The LLC controller 1133 coupled to a remote digital device 1130 through data isolation circuit 1110. The remote digital device 1130 transmits a transmit signal TS1, receives a receive signal RS1, and receives a clock signal SCLK, that respectively represent a sequence of transmitted information bits, received information bits, and received clocking bits. The data isolation circuit 1110 receives the transmit signal TS1, transmits the receive signal RS1, and transmits the clock signal SCLK to/from remote digital device 1130. The data isolation circuit 1110 is coupled to a current sense terminal CS and gate drive terminal GD of the LLC controller 1133.

The data isolation circuit 1110 provides isolation and timing functions between the LLC controller 1133 and the remote digital device 1130. The data isolation circuit 1110 is formed with a digital isolator 1120 and buffer amplifiers B1, B2. The digital isolator 1120 provides an isolation function for the remote digital device 1130 such as providing a signal isolation transformer to enable metallic isolation of local circuit grounds between the LLC controller 1133 and the remote digital device 1130. The buffer amplifiers B1, B2 (operations of which are conditioned by the gate drive signal GDM₂) provide timing isolation for digital signals coupled to the current sense terminal CS. In addition, the buffer amplifiers B1, B2 accommodate external digital impedances of the buffer amplifiers B1, B2 coupled to the current sense terminal CS.

In operation, the transmit signal TS1 transmitted by remote digital device 1130 is isolated and coupled as a received signal RX as an input to the buffer amplifier B1. The output of buffer amplifier B1 is coupled through a resistor R10 to the current sense terminal CS. A transmit signal TX transmitted from the current sense terminal CS is coupled through the buffer amplifier B2 to the digital isolator 1120. The transmit signal TX produced at current sense terminal CS is coupled through a resistor R20 to an input of the buffer amplifier B2, the output of which is coupled as the received signal RS1 via the digital isolator 1120 to the remote digital device 1130. The gate drive signal GDM₂ that controls the auxiliary power switch M₂ is coupled to the remote digital device 1130 through the digital isolator 1120 to identify the complementary duty cycle 1-D during which time the remote digital device 1130 can transmit and receive data to and from the LLC controller 1133.

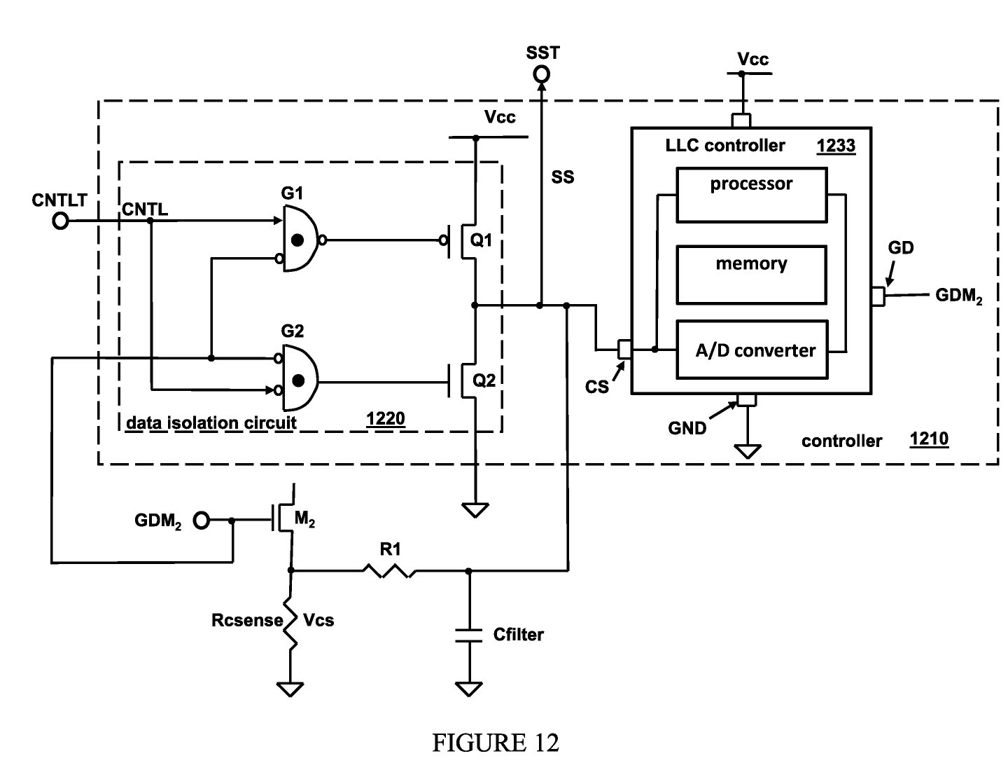

Turning now to FIG. 12, illustrated is a block diagram of an embodiment of a controller 1210 formed with an LLC controller 1233 and a data isolation circuit 1220 constructed according to the principles of the present invention. The LLC stage includes main and auxiliary power switches M₁, M₂, of which the auxiliary power switch M₂ is illustrated therein. The controller 1210 is formed with the data isolation circuit 1220 configured to isolate an impedance of an input digital data source presented at a control signal terminal CNTLT from a current sense terminal CS of the LLC controller 1233 during periods of time when auxiliary power switch M₂ is enabled to conduct and when current flowing through the auxiliary power switch M₂ is sensed by the current sense terminal CS. The current sense terminal CS produces a status signal for an external digital device at the status signal terminal SST during periods of time when auxiliary power switch M₂ is disabled to conduct.

The data isolation circuit 1220 is formed with AND gates G1, G2 and a P-channel MOSFET Q1 with a drain coupled to a drain of N-channel MOSFET Q2. A gate drive signal GDM₂ is coupled to inverting inputs of the AND gates G1, G2. A control signal CNTL from the input digital data source is coupled to a non-inverting input of the AND gate G1 and to an inverting input of the AND gate G2. When the gate drive signal GDM₂ is high, i.e., when auxiliary power switch M₂ is enabled to conduct, an inverting output of the AND gate G1 is high, disabling the P-channel MOSFET Q1 to conduct, and a non-inverting output of and the AND gate G2 is low, disabling the N-channel MOSFET Q2 to conduct. Accordingly, when the gate drive signal GDM₂ is high and the auxiliary power switch M₂ is enabled to conduct, the data isolation circuit 1220 presents a high impedance to the current sense terminal CS, thereby enabling the current sense terminal CS to accurately sense a current sense voltage V_{CS} produced across the current sense resistor Rcsense.

When the gate drive signal GDM₂ is low, i.e., when the auxiliary power switch M₂ is disabled to conduct, an inverting output of the AND gate G1 is logically inversely responsive to the control signal CNTL at the control signal terminal CNTLT, and a non-inverting output of the AND gate G2 is logically directly responsive to the control signal CNTL. The net result is when the gate drive signal GDM₂ is low, the control signal CNTL directly drives the current sense terminal CS. Accordingly, the data isolation circuit 1220 isolates the current sense terminal CS from the control signal CNTL when the auxiliary power switch M₂ is enabled to conduct, and directly couples the control signal CNTL (via the control signal terminal CNTLT) to the current sense terminal CS when the auxiliary power switch M₂ is disabled to conduct. The gate drive signal GDM₂ is employed to provide a timing window to receive the control signal CNTL when the auxiliary power switch M₂ is disabled to conduct.

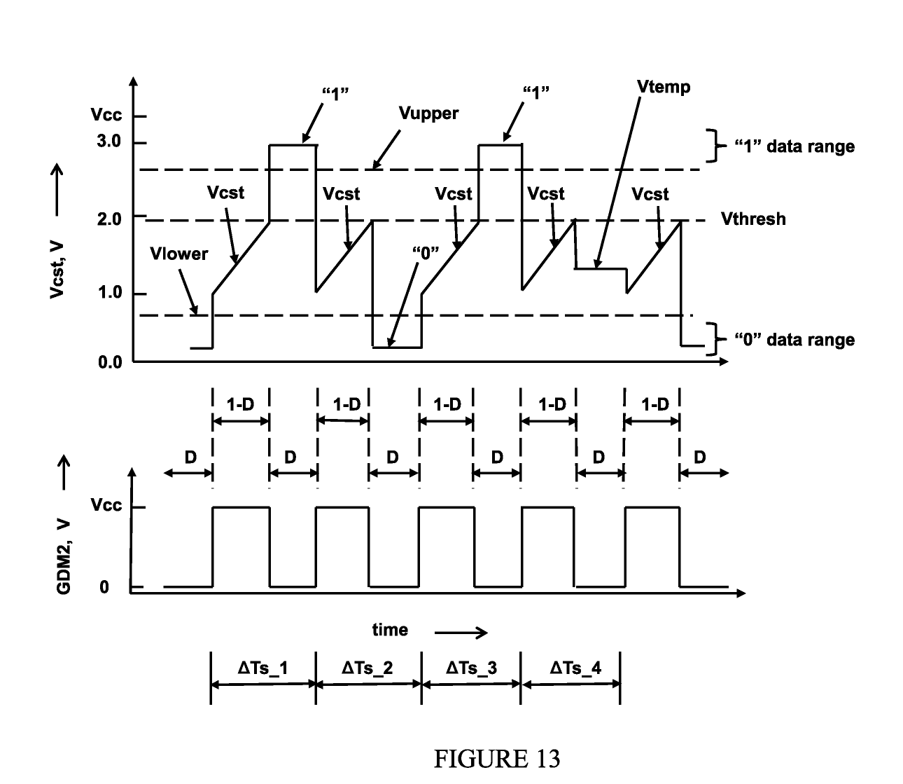

Turning now to FIG. 13, illustrated are graphical representations demonstrating exemplary operating characteristics of a power converter according to the principles of the present invention. An upper portion of the FIG. 13 is a graphical representation of a timing diagram showing a current sense terminal voltage Vcst produced at a current sense terminal CS, and in the lower portion of the FIG. 13, a gate drive signal GDM₂ is shown on a common time base. A first and second portion of the switching intervals or cycles of an auxiliary power switch M₂ are illustrated including the first, second, third and fourth switching cycles ΔTs_{—}1, ΔTs_{—}2, ΔTs_{—}3, ΔTs_{—}4, respectively. The first and second portions of the switch cycles are designated as the complementary duty cycle 1-D and primary duty cycle D, respectively, to be consistent with the description above.

In the upper portion of the FIG. 13, an upper voltage threshold Vupper is illustrated, above which the current sense terminal voltage Vcst is interpreted as a logical “1.” A lower voltage threshold Vlower is also illustrated, below which the current sense terminal voltage Vcst is interpreted as a logical “0.” Also illustrated is a threshold voltage Vthresh produced by an error amplifier in an LLC controller (e.g., error amplifier 345 illustrated and described hereinabove with reference to FIG. 7) that is employed to interpret an analog voltage produced at the current sense terminal CS to control the primary and complementary duty cycles D, 1-D of the auxiliary power switch M₂.

Accordingly, during the first switching cycle ΔTs_{—}1, the complementary duty cycle 1-D is terminated by the LLC controller when the current sense terminal voltage Vcst crosses the threshold voltage Vthresh. During the primary duty cycle D of the first switching cycle ΔTs_{—}1, the current sense terminal voltage Vcst exceeds the upper voltage threshold Vupper, and is interpreted by the LLC controller as a “1” bit. During the primary duty cycle D of a second switching cycle ΔTs_{—}2, the current sense terminal voltage Vcst is less than the lower voltage threshold Vlower, and is interpreted by the LLC controller as a “0” bit. During the primary duty cycle D of a fourth switching cycle ΔTs_{—}4, the current sense terminal voltage Vcst lies between the upper voltage threshold Vupper and the lower voltage threshold Vlower, and is interpreted by the LLC controller as an analog voltage, e.g., a voltage representing a temperature as produced by a thermistor Rtherm.

The controller or related method may be implemented as hardware (embodied in one or more chips including an integrated circuit such as an application specific integrated circuit), or may be implemented as software or firmware for execution by a processor (e.g., a digital signal processor) in accordance with memory. In particular, in the case of firmware or software, the exemplary embodiment can be provided as a computer program product including a computer readable medium embodying computer program code (i.e., software or firmware) thereon for execution by the processor.

Program or code segments making up the various embodiments may be stored in computer readable medium. For instance, a computer program product including a program code stored in a computer readable medium (e.g., a non-transitory computer readable medium) may form various embodiments. The “computer readable medium” may include any medium that can store or transfer information. Examples of the computer readable medium include an electronic circuit, a semiconductor memory device, a read only memory (“ROM”), a flash memory, an erasable ROM (“EROM”), a floppy diskette, a compact disk (“CD”)-ROM, and the like.

Those skilled in the art should understand that the previously described embodiments of a controller for a power converter with increased functionality for a current sense pin/terminal and related methods of forming the same are submitted for illustrative purposes only. While a controller for a power converter with increased functionality for a current sense pin/terminal as described hereinabove may also be applied to other systems such as, without limitation, a power amplifier and a motor controller.

For a better understanding of power converters, see “Modern DC-to-DC Power Switch-mode Power Converter Circuits,” by Rudolph P. Severns and Gordon Bloom, Van Nostrand Reinhold Company, New York, N.Y. (1985) and “Principles of Power Electronics,” by J. G. Kassakian, M. F. Schlecht and G. C. Verghese, Addison-Wesley (1991). The aforementioned references are incorporated herein by reference in their entirety.

Also, although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A controller for use with a power converter, comprising:
a gate drive terminal configured to provide a gate drive signal to enable conductivity of a power switch during a first portion of a switching interval and to disable conductivity of said power switch during a second portion of said switching interval; and
a current sense terminal configured to:
receive a power switch signal indicative of a current in said power switch during said first portion of said switching interval, and
receive a control signal to operate said power converter or provide a status signal indicative of an operating condition of said power converter during said second portion of said switching interval.

2. The controller as recited in claim 1 wherein said first and second portions of said switching interval each represent one of a primary duty cycle and a complementary duty cycle.

3. The controller as recited in claim 1 wherein a current sense terminal voltage at said current sense terminal is set by a resistor divider network formed by a thermistor coupled to a bias voltage source and a series combination of a resistor and a current sense resistor coupled to said power switch.

4. The controller as recited in claim 1 further comprising a processor and a memory configured to produce said gate drive signal.

5. The controller as recited in claim 1 wherein said current sense terminal is configured to receive said control signal to operate said power converter or provide said status signal indicative of an operating condition of said power converter substantially during a middle of said second portion of said switching interval.

6. The controller as recited in claim 1 wherein said controller is configured to determine said first portion of said switching interval.

7. The controller as recited in claim 1 further comprising a current mirror including first and second switches coupled to said current sense terminal.

8. The controller as recited in claim 1 further comprising a current mirror operative to provide a high impedance to said current sense terminal.

9. The controller as recited in claim 1 further comprising a data isolation circuit configured to isolate a control signal terminal from said current sense terminal during said first portion of said switching interval.

10. The controller as recited in claim 1 further comprising a data isolation circuit configured to couple a control signal terminal to said current sense terminal during said second portion of said switching interval.

11. The controller as recited in claim 1 wherein said gate drive signal is employed to provide a timing window to receive a control signal during said second portion of said switching interval.

12. A method of operating a controller for use with a power converter, comprising:
providing a gate drive signal to enable conductivity of a power switch during a first portion of a switching interval and to disable conductivity of said power switch during a second portion of said switching interval; and
receiving a power switch signal indicative of a current in said power switch from a current sense terminal during said first portion of said switching interval, and
receiving a control signal to operate said power converter or provide a status signal indicative of an operating condition of said power converter from said current sense terminal during said second portion of said switching interval.

13. The method as recited in claim 12 wherein said first and second portions of said switching interval each represent one of a primary duty cycle and a complementary duty cycle.

14. The method as recited in claim 12 further comprising setting a current sense terminal voltage at said current sense terminal by a resistor divider network formed by a thermistor coupled to a bias voltage source and a series combination of a resistor and a current sense resistor coupled to said power switch.

15. The method as recited in claim 12 wherein said receiving said control signal to operate said power converter or providing said status signal indicative of said operating condition of said power converter occurs substantially during a middle of said second portion of said switching interval.

16. The method as recited in claim 12 further comprising determining said first portion of said switching interval.

17. The method as recited in claim 12 further comprising providing a high impedance to said current sense terminal.

18. The method as recited in claim 12 further comprising isolating a control signal terminal from said current sense terminal during said first portion of said switching interval.

19. The method as recited in claim 12 further comprising coupling a control signal terminal to said current sense terminal during said second portion of said switching interval.

20. The method as recited in claim 12 wherein said gate drive signal is employed to provide a timing window to receive a control signal during said second portion of said switching interval.
